(19) United States
(12) Patent Application Publication
(10) Pub. No.: US 2017/0109365 A1
(43) Pub. Date: Apr. 20, 2017

(54) FILE PROCESSING METHOD, FILE PROCESSING APPARATUS AND ELECTRONIC EQUIPMENT

(71) Applicant: Sony Mobile Communications Inc., Tokyo (JP)

(72) Inventor: Vincent GUO, Beijing (CN)

(21) Appl. No.: 14/906,817

(22) PCT Filed: Aug. 31, 2015
(86) PCT No.: PCT/IB2015/056611

§ 371 Date: Jan. 21, 2016

(30) Foreign Application Priority Data
May 15, 2015 (CN) 201510247077.3

(51) Int. Cl. G06F 17/30; H04L 12/58

(52) U.S. Cl. CPC G06F 17/30106; H04L 51/32; G06F 17/30867; G06F 17/3007

(57) ABSTRACT

Embodiments of the present application provide a file processing apparatus and method and electronic equipment. The file processing apparatus includes: a first recording unit configured to post a local file in a social network, so as to form that post information to which the posted file corresponds is recorded in association with the local file; and a second recording unit configured to record a comment content in the social network related to the posted file in association with the local file according to the post information. According to this application, the comment in the social network is recorded in association with the local file. Thus, when a user locally looks up the local file, related comments may also be looked up, thereby increasing enjoyment in looking up files locally.

### CROSS-REFERENCE To RELATED APPLICATION AND PRIORITY CLAIM

This application claims the benefit of CN Patent Application Serial No. 201510247077.3, filed May 15, 2015, the entire disclosure of which is hereby incorporated by reference.

### TECHNICAL FIELD

The present disclosure relates to the field of information technology, and in particular to a file processing method, a file processing apparatus and electronic equipment.

### BACKGROUND

Network technologies can integrate discrete resources in the Internet into organic aggregations, thereby achieving overall sharing and coordination of the resources.

The occurrence of the social network greatly enriches social circles of the people. Users may post photos, videos and/or music, etc., in a social network, via social network service software, such as Facebook, Twitter, and Wechat, etc., and the posted files will be commented by the friends, thereby increasing enjoyment in sharing.

It should be noted that the above description of the background art is merely provided for clear and complete explanation of the present disclosure and for easy understanding by those skilled in the art. And it should not be understood that the above technical solution is known to those skilled in the art as it is described in the background art of the present disclosure.

### SUMMARY

It was found by the inventors of this application that a user can see the comments on the posted files only when the user logs in the social network, and if the user only opens a file locally, the user cannot see related comments. This makes the user unable to experience the enjoyment that the user shared before when the user locally looks up the file.

Embodiments of this application provide a file processing method, a file processing apparatus and electronic equipment, which may record comments on a posted file in the network in association with the local file. Hence, when a user locally looks up the local file, the user may see the comments related to the local file, thereby increasing enjoyment in looking up the file locally.

According to a first aspect of the embodiments of the present disclosure, there is provided a file processing apparatus, including:

a first recording unit configured to record post information in association with a local file, when the local file is posted in a social network to form a posted file (sometimes the term unit is referred to as module, the terms unit and module and the like being used equivalently and interchangeable); and

a second recording unit configured to record a comment content in the social network related to the posted file in association with the local file according to the post information.

According to a second aspect of the embodiments of the present disclosure, the post information and the comment content are recorded in the local file, or are recorded out of the local file.

According to a third aspect of the embodiments of the present disclosure, the post information and the comment content are recorded in attribute information of the local file.

According to a fourth aspect of the embodiments of the present disclosure, the post information and the comment content are recorded as metadata in the attribute information of the local file.

According to a fifth aspect of the embodiments of the present disclosure the second recording unit includes:

a detecting unit configured to detect the comment content in the social network related to the posted file;

a searching unit configured to search the local file corresponding to the comment content according to the post information; and

a third recording unit configured to record the comment content in association with the local file.

According to a sixth aspect of the embodiments of the present disclosure, there is provided electronic equipment, including the file processing apparatus as described in any one of the first to the fifth aspects.

According to a seventh aspect of the embodiments of the present disclosure, there is provided a file processing method, including:

recording post information in association with a local file, when the local file is posted in a social network to form a posted file; and

recording a comment content in the social network related to the posted file in association with the local file according to the post information.

According to an eighth aspect of the embodiments of the present disclosure, the post information and the comment content are recorded in the local file, or are recorded out of the local file.

According to a ninth aspect of the embodiments of the present disclosure, the post information and the comment content are recorded in attribute information of the local file.

According to a tenth aspect of the embodiments of the present disclosure, the post information and the comment content are recorded as metadata in the attribute information of the local file.

According to an eleventh aspect of the embodiments of the present disclosure the recording a comment content in association with the local file includes:

detecting the comment content in the social network related to the posted file;

searching the local file corresponding to the comment content according to the post information; and

recording the comment content in association with the local file.

An advantage of the embodiments of the present disclosure exists in that the comments in the network are recorded in association with the local file. Hence, when a user locally looks up the local file, the user may see the comments related to the local file at the same time, thereby increasing enjoyment in looking up the file locally.

With reference to the following description and drawings, the particular embodiments of the present disclosure are disclosed in detail, and principles of the present disclosure and the manners of use are indicated. It should be understood that the scope of the embodiments of the present disclosure is not limited thereto. The embodiments of the present disclosure contain many alternations, alterations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth principles of the present disclosure together with the description. The accompanying drawings described below are some embodiments of the present disclosure only, and to those skilled in the art, other accompanying drawings may be obtained according to these accompanying drawings without making an inventive effort.

In the drawings:

FIG. 1 is a flowchart of a file processing method of Embodiment 1;

FIG. 2 is a flowchart of a method for recording a comment content in association with a local file of Embodiment 1;

FIG. 3 is a flowchart of an example of the file processing method of Embodiment 1;

FIG. 4 is a schematic diagram of attribute information of a local photo file;

FIGS. 5(a), 5(b) and 5(c) are schematic diagrams of displaying comment contents in association with local photo files;

FIG. 6 is a schematic diagram of a structure of a file processing apparatus of Embodiment 2;

FIG. 7 is a schematic diagram of a structure of a second recording unit of Embodiment 2; and

FIG. 8 is a schematic diagram of a structure of electronic equipment of Embodiment 3 of this application.

### DESCRIPTION

The foregoing and other features of the present disclosure shall become apparent from the following description with reference to the accompanying drawings. Particular embodiments of the present disclosure are disclosed in the description and drawings, which indicate part of the embodiments that may employ principles of the present disclosure. It should be understood that the present disclosure is not limited to the described embodiments, on the contrary, the present disclosure includes all the modifications, variations and equivalents falling within the scope of the appended claims.

### Embodiment 1

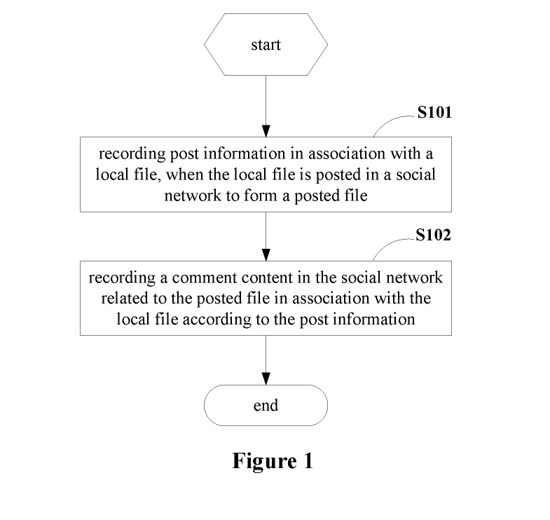

Embodiment 1 of this application provides a file processing method. FIG. 1 is a flowchart of the file processing method of Embodiment 1 of this application. As shown in FIG. 1, the method includes:

S101: recording post information in association with a local file, when the local file is posted in a social network to form a posted file (the prefix “S” preceding a number herein represents a step or steps, procedure, process, etc.); and

S102: recording a comment content in the social network related to the posted file in association with the local file according to the post information.

In this embodiment, the comment in the social network is recorded in association with the local file. Hence, when a user locally looks up the local file, the user may see the related comment at the same time, thereby increasing enjoyment in looking up the file locally.

In this embodiment, the local file may be a file stored in electronic equipment of the user, and the electronic equipment may be, for example, a mobile phone, a digital camera, a tablet computer, and a personal computer, etc.; furthermore, in this embodiment, the local file may also be a file stored in a server designated by a user, such as a file stored in a cloud server designated by a user.

In this embodiment, the local file may be, for example, a picture file, a video file, an audio file, or a text file, etc.; however, this embodiment is not limited thereto, and may also be files in other formats.

In this embodiment, the local file may be posted in a social network via social network service software or by logging in the social network service website by a webpage browser, so as to form the posted file. The social network service software may be, for example, Facebook, Twitter, and Wechat, etc.

In S101 of this embodiment, when the local file is posted in the social network to form a posted file, the post information is recorded in association with the local file. The post information may be used to identify the identity of the posted file in the social network. Hence, the posted file may be associated with the local file by recording the post information in association with the local file.

In this embodiment, the post information may include, for example, a post ID, and the posted file may be identified in the social network according to the post ID; furthermore, different social network services may correspond to post IDs of different formats. Hence, a social network via which the posted file is posted may be determined according to a format of the post ID.

In this embodiment, the post information may further include information that identifies the social network service, hence, the social network service via which the posted file is posted may be determined more accurately. Furthermore, in this embodiment, the post information may further include other information, such as a post time; however, this embodiment is not limited to the above.

In this embodiment, the post information may be directly generated by a social network service; however, this embodiment is not limited thereto, and the post information may be generated by processing information generated by the social network service. For example, the information generated by the social network service may be encoded and processed again, so as to generate the post information of unified formats.

In this embodiment, when the local file is posted via multiple social network services respectively, multiple pieces of post information corresponding respectively to the multiple social network services may be generated, and may be recorded in association with the local file, thereby associating the posted file posted via different social network services with the local file.

In this embodiment, the acquired post information may be recorded in the local file. For example, the post information may be recorded as metadata in attribute information of the local file. However, this embodiment is not limited thereto, and the post information may also be recorded in other information of the local file.

In this embodiment, the acquired post information may also be recorded out of the local file. For example, the post information may be stored in an independent file, and the independent file may store identification information of the local file in association with the posted file; and the identification information of the local file may be, for example, the name of the local file, etc.

In S102 of this embodiment, the comment content related to the posted file in the social network may be recorded in association with the local file. Thus, when the user looks up the local file, the user may look up the comment content at the same time.

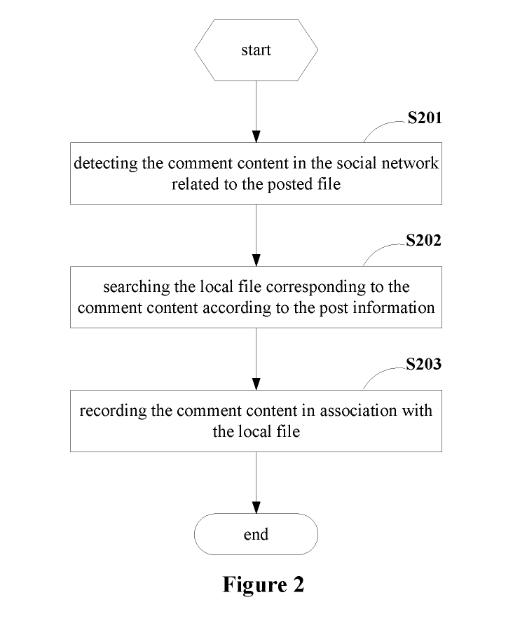

FIG. 2 is a flowchart of a method for recording a comment content in association with a local file of Embodiment 1. As shown in FIG. 2, the method includes:

S201: detecting the comment content in the social network related to the posted file;

S202: searching the local file corresponding to the comment content according to the post information; and

S203: recording the comment content in association with the local file.

In S201 of this embodiment, whether there exists a comment content on the posted file in the social network may be detected, and whether the comment content is updated may further be judged, e.g., determined, sensed, detected, etc. For example, in a case where the comment content in the social network is associated with the post information of the posted file, the comment content on the posted file may be extracted according to the post information, and whether the comment content is updated may further be judged, e.g., determined, sensed, detected, etc. A particular method for detecting the comment content may be, for example, when the social network service is Facebook, extracting a current comment content of a posted photo according to an attribute of “a message” of “/{photo-id}/comments”, extracting a number of current comments of the posted photo by using an attribute of “total_count”, and judging whether the comment content is updated by comparing it with a previous comment content or number of comments. The prior art may be referred to for other techniques of detecting the comment content, which shall not be described in this embodiment any further.

In S202 of this embodiment, when it is judged, e.g., determined, sensed, detected, etc., that there exists a comment content on the posted file in the social network or the comment content is updated, the local file corresponding to the post information may be searched locally according to the post information associated with the comment content, so that the comment content corresponds to the local file. For example, when the post information is recorded in the local file, the post information associated with the comment content may be compared with the post information recorded in the local file, and if they are consistent, it may be determined that the comment content corresponds to the local file; or, when the identification information of the local file is stored in association with the post information in an independent file out of the local file, the post information associated with the comment content may be compared with the post information recorded in the independent file, and if they are consistent, it may be determined that the comment content corresponds to the local file associated with the post information recorded in the independent file.

In S203 of this embodiment, the comment content is recorded in association with the local file. In this embodiment, the comment content may be recorded in the corresponding local file. For example, the comment content may be recorded as metadata in the attribute information of the local file. However, this embodiment is not limited thereto, and the post information may also be recorded in other information of the local file; in this embodiment, the comment content may also be recorded out of the local file. For example, the comment content may be stored in an independent file, and the independent file may store the identification information of the local file in association with the comment content; and the identification information of the local file may be, for example, the name of the local file, etc.

In this embodiment, in a case where the local file is associated with the comment content, when the local file is looked up, the comment content may be displayed at the same time. However, a manner of displaying the comment content and the local file is not limited in this embodiment. For example, the comment content and the local file may be displayed in any one or two or more of the following manners 1-6.

Manner 1: in looking up the local file, it is defaulted that the local file is displayed and the comment content is hidden, and when the user touches a part of the displayed local file or moves the mouse to this part, a comment content related to this part is displayed. For example, when the local file is a photo file, an existing image identification method may be used to identify an object existed in the photo file, and the comment content associated with the local file may be analyzed, so as to determine a corresponding relationship between the comment content and the object in the photo file. Hence, when the photo file is looked up in a local display, if the user touches a position corresponding to the object in the displayed local file or moves the mouse to this position, the comment content related to the object is displayed on the display.

Manner 2: in looking up the local file, the displayed comment content is automatically ordered or filtered. For example, when the user looks up the comment content related to the posted file in the social network, physiological parameters of the user, such as blood pressure, may be detected according to a wearable device worn by the user, so as to determine a level of favor of each comment content of the user, or semantic analysis is performed on the comment content to determine a level of favor of each comment content of the user, and a tag is added to each comment content according to the level of favor. Hence, when the local file is looked up, the displayed comment content is automatically ordered or filtered according to the tag of each comment content. For example, a comment content of a high level of favor of the user may be displayed on the front, and a comment content of a low level of favor of the user may be filtered and is not displayed.

Or, in this embodiment, a comment related to a multimedia file that is being played may be displayed according to the content of the multimedia file that is being played by local electronic equipment. For example, when the local electronic equipment is playing a music file, a comment content in the local photo file may be looked up, so as to extract a comment content mentioning the music and preferentially display it on the display of the electronic equipment.

Or, in this embodiment, the displayed comment contents may be ordered according to geographical position information described by the local electronic equipment. For example, when the user looks up a local photo file in a mobile phone, a comment content posted by a friend in the same city as the user may be preferentially displayed.

Manner 3: in this embodiment, comment contents recorded in association with the local file may be grouped, and comment contents related to a selected group and a local file to which the comment contents correspond may be displayed. For example, locally recorded comment contents may be grouped according to different commentators and/or different subjects, such as sports, foods, reading and/or travelling, etc., and the comment contents related to the selected group and a local photo file to which the comment contents correspond may be displayed on the display of the electronic equipment according to the group selected by the user, and comment contents and photo files of other groups may be hidden.

Manner 4: in this embodiment, the local file may be displayed in an associated manner. For example, if ten photos are shot for the same peak, e.g., a mountain peak, and only one of them is commented after post, when the user browses the photo with associated comment, the other nine photos with no comment may also be displayed in an associated manner.

Manner 5: in this embodiment, when a local file associated with a comment content is transmitted or shared in the network, the comment content may be encrypted, or the local file is disassociated from the comment content, thereby avoiding the comment content associated with the local file from being disclosed. For example, in a case where the comment content is recorded in attribute information of a local photo, when it is needed to transmit the local photo via the network, the comment content may be encrypted, or the comment content recorded in attribute information of the local photo may be deleted.

Manner 6: in this embodiment, the comment content may be displayed when correct verification information is inputted. For example, when a local photo associated with a comment content in a mobile phone is looked up, the user may be required to input verification information, such as a password, or a fingerprint, etc., and if the inputted verification information is correct, the associated comment content may be displayed, thereby avoiding other people than the user of the mobile phone from viewing a comment content that is not expected to be viewed.

With this embodiment, the post information may be recorded in association with the local file, and the comment in the social network may also be recorded in association with the local file. In this way, the user may look up related comment without logging in the social network in looking up the local file, thereby increasing enjoyment in looking up files locally.

The file processing method of Embodiment 1 of this application will be described below by way of an example. In this example, the local file may be in the electronic equipment of the user and may be a photo file, and the post information and the comment content may be recorded as metadata in the attribute information of the photo file.

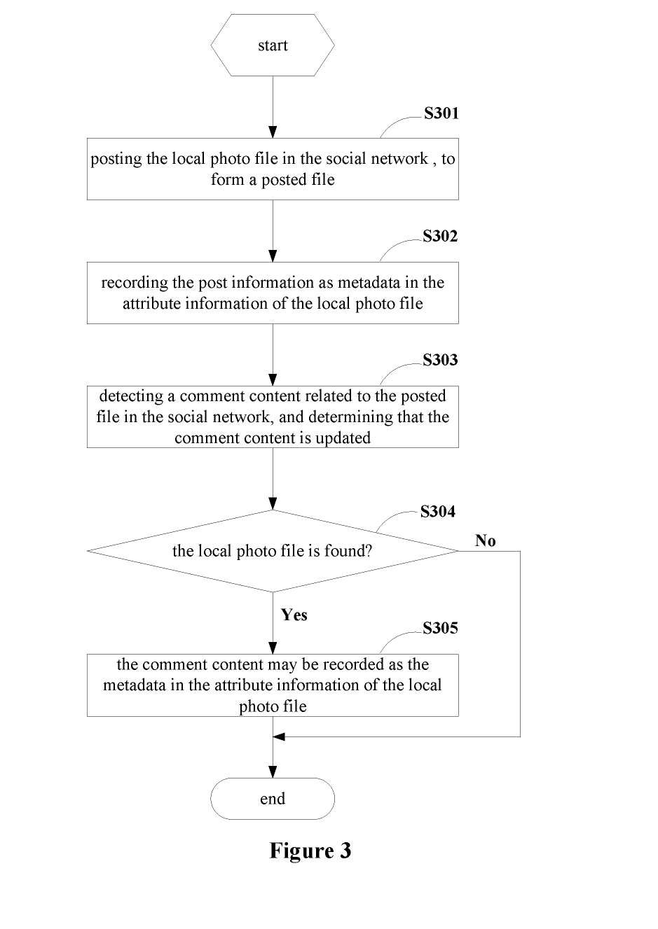

FIG. 3 is a flowchart of the file processing method of this example. As shown in FIG. 3, the method includes:

S301: posting the local photo file in the social network via social network service software, so as to form a posted file; for example, the local photo file may be posted in the social network via Wechat, Twitter, and/or Facebook;

S302: recording the post information as metadata in the attribute information of the local photo file, the post information including information on social network service software, and a post ID.

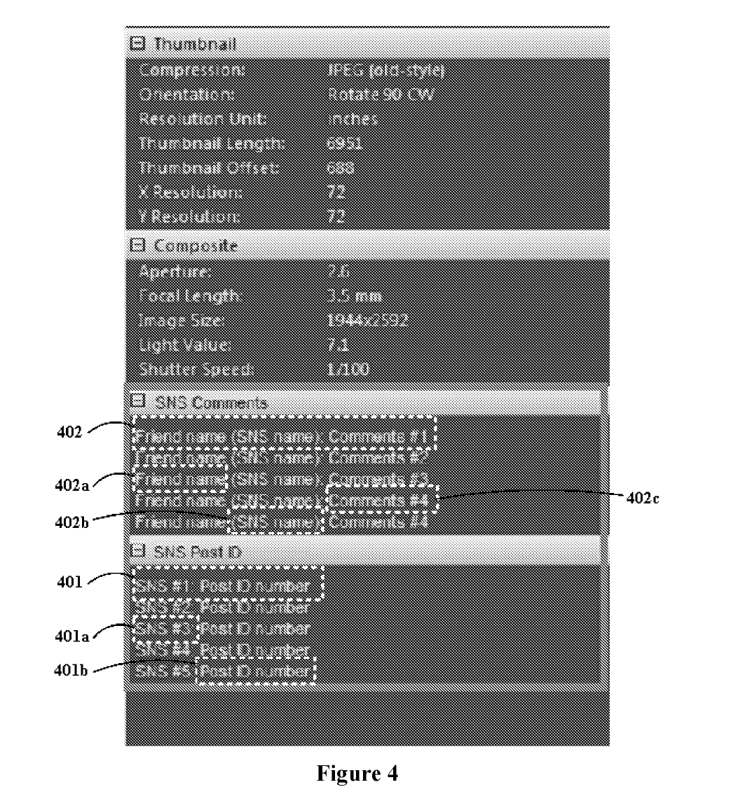

FIG. 4 is a schematic diagram of the attribute information of the local photo file. As shown in FIG. 4, 401 denotes the post information as the metadata; and multiple pieces of post information may be recorded in the attribute information, and each piece of post information 401 may include information 401a on the social network service software, and a post ID 401b.

S303: detecting a comment content related to the posted file in the social network, and determining that the comment content is updated;

S304: searching a local photo file corresponding to the same post information as said comment content, and terminating the process if the local photo file is not found; for example, it is possible that the user has deleted the local photo file from the electronic equipment, hence, the comment content cannot be associated with the local photo file.

In a case where it is judged, e.g., determined, sensed, detected, etc., in S304 that the local photo file is found, S305 is executed, where the comment content may be recorded as the metadata in the attribute information of the local photo file. For example, in FIG. 4, 402 denotes the comment content as the metadata; and, multiple comment contents may be recorded in the attribute information, and each comment content 402 may include information 402a on a poster of the comment, information 402b on the social network service software, and a text 402c of the comment.

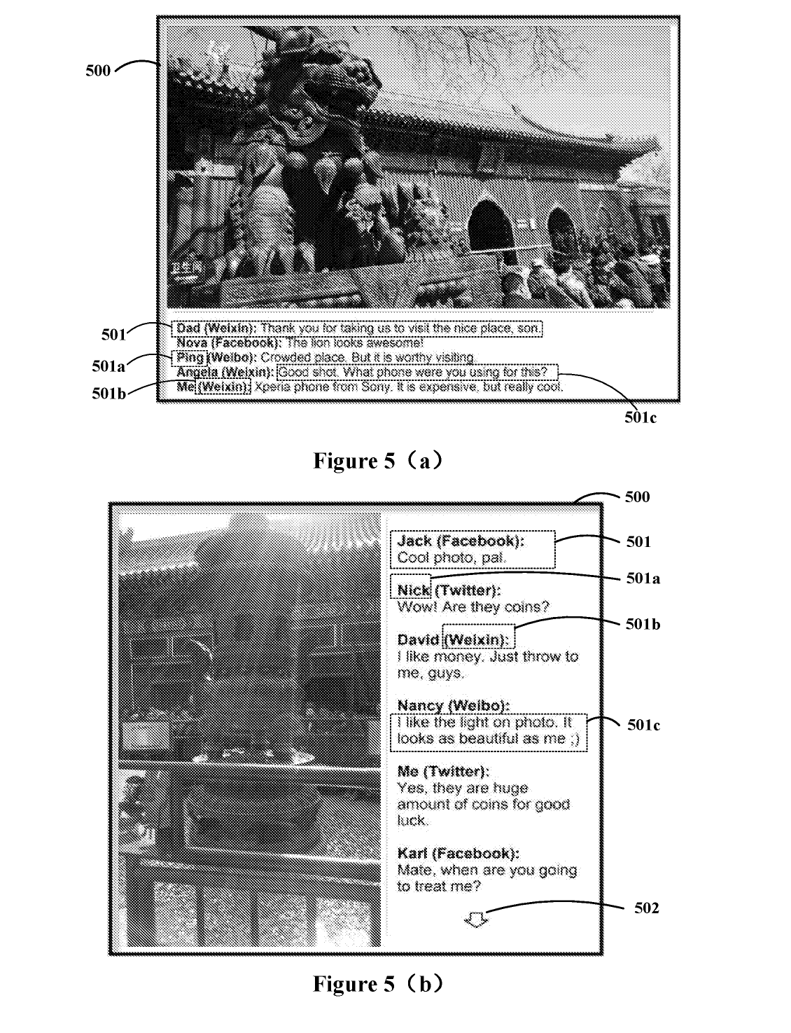

FIG. 5 is a photo image displayed when the user locally looks up the local photo file in a case where the comment contents are recorded in association with the local photo file. As shown in FIGS. 5(a) and 5(b), comment contents 501 in the social network may be displayed in the photo image 500. There may be multiple comment contents 501, and each displayed comment content 501 may include a name 501a of a poster of the comment, information 501b on the social network service software, and a text 501c of the comment.

In this embodiment, as shown in FIGS. 5(a) and 5(b), a display position of the comment content may be determined according to a displaying direction of the photo file. For example, in FIG. 5(a), the photo is displayed horizontally, and the comment content 501 may be displayed at the upper side or the lower side of the photo image; and in FIG. 5(b), the photo is displayed vertically, and the comment content 501 may be displayed at the left side or the right side of the photo image. Of course, this embodiment is not limited thereto, and the comment content may also be displayed at other positions.

As shown in FIG. 5(b), in this embodiment, when there are multiple comment contents, the photo image may further display an icon 502, and other comment contents may be displayed in a rolling manner or a switched manner by clicking the icon by the user.

In this embodiment, as shown in FIG. 5(c), it may be defaulted that the local photo is displayed in looking up the local photo, and the content is hidden. And when the user touches a part of the photo or moves the mouse to this part, the comment content 501 related to this part is displayed.

According to this embodiment, in locally browsing photos, the user may look up a comment content obtained when the photo is posted in the social network, thereby increasing enjoyment in looking up photos locally.

### Embodiment 2

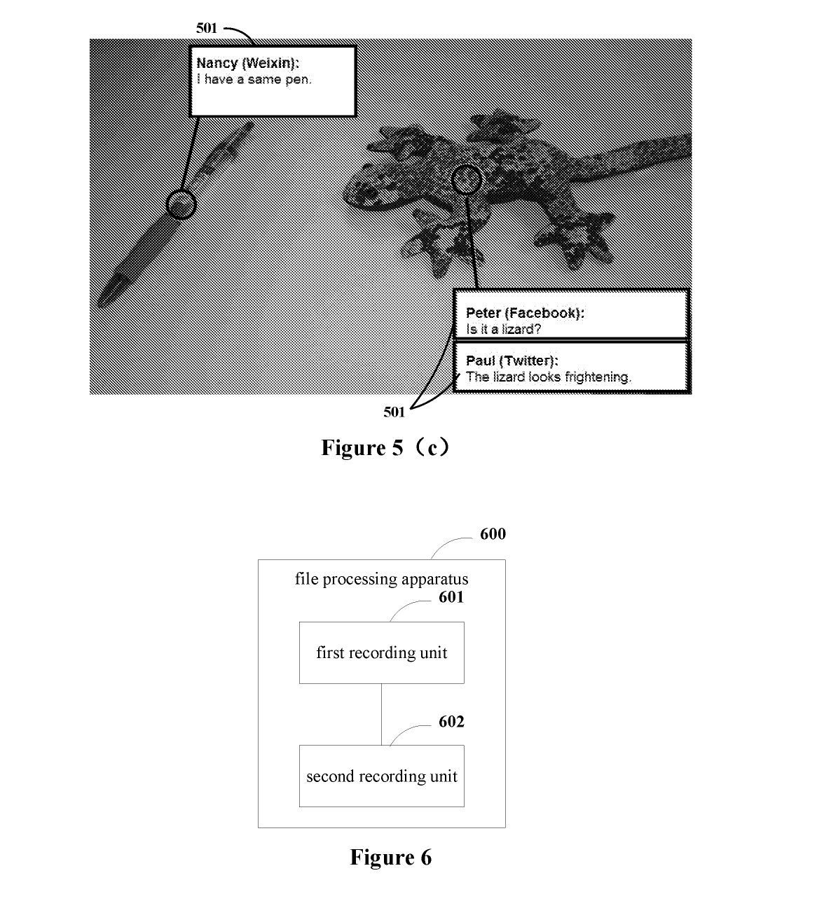

Embodiment 2 of this application provides a file processing apparatus, corresponding to the file processing method of Embodiment 1. FIG. 6 is a schematic diagram of a structure of the file processing apparatus of Embodiment 2. As shown in FIG. 6, the file processing apparatus 600 includes a first recording unit 601 and a second recording unit 602.

In this embodiment, the first recording unit 601 is configured to record post information in association with a local file, when the local file is posted in a social network to form a posted file. The second recording unit 602 is configured to record a comment content in the social network related to the posted file in association with the local file according to the post information.

In this embodiment, the post information and the comment content may be recorded as metadata in attribute information of the local file, or may be recorded in other information of the local file, and may also be recorded out of the local file.

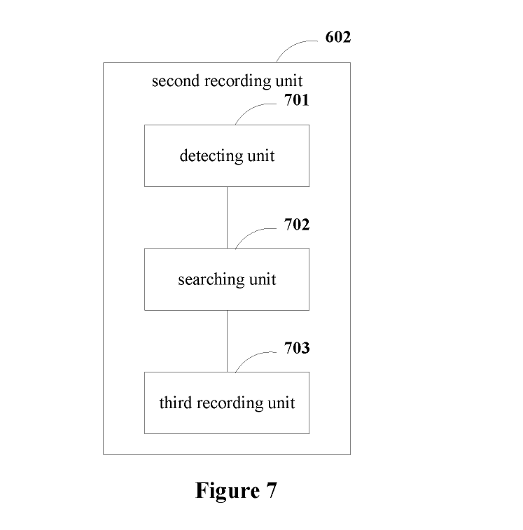

FIG. 7 is a schematic diagram of a structure of the second recording unit of Embodiment 2. As shown in FIG. 7, the second recording unit 602 may include a detecting unit 701, a searching unit 702 and a third recording unit 703.

In this embodiment, the detecting unit 701 is configured to detect the comment content in the social network related to the posted file, the searching unit 702 is configured to search the local file corresponding to the comment content according to the post information, and the third recording unit 703 is configured to record the comment content in association with the local file.

In this embodiment, the file processing apparatus 600 may further include a display control unit (not shown). The display control unit may control the display of the local file and the comment content when the local file is associated with the comment content. For example, the display control unit may control that when the local file is looked up, the comment content is displayed at the same time; or the display control unit may control that the local file and the comment content are displayed in any one or two or more of the manners 1-6 described in Embodiment 1.

In this embodiment, explanation of the steps of the file processing method Embodiment 1 may be referred to for the units of the file processing apparatus, which shall not be described in this embodiment any further.

With this embodiment, the post information may be recorded in association with the local file, and the comment in the social network may also be recorded in association with the local file. In this way, the user may look up related comment without logging in the social network in looking up the local file, thereby increasing enjoyment in looking up files locally.

### Embodiment 3

An embodiment of the present disclosure further provides electronic equipment, including the file processing apparatus described in Embodiment 2.

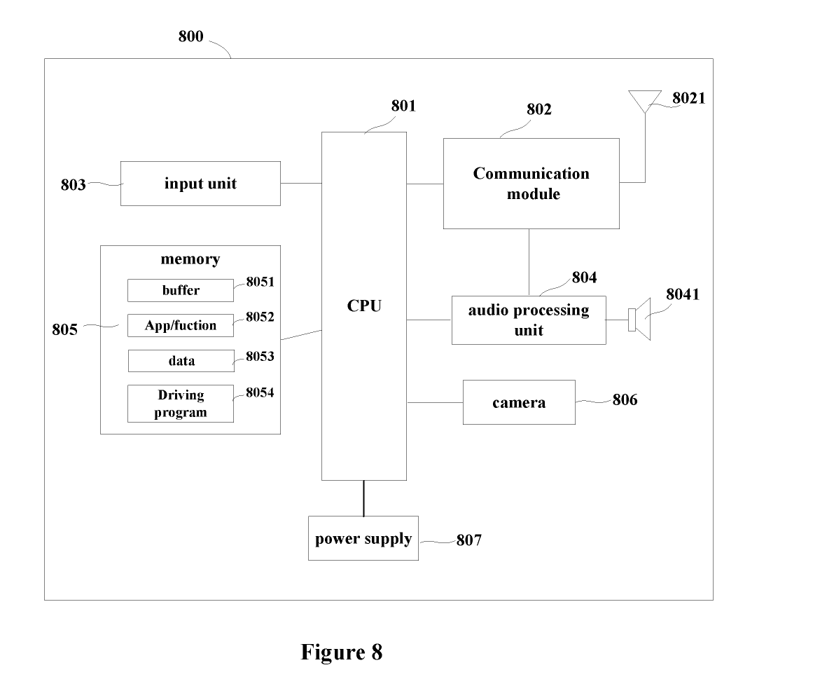

FIG. 8 is a schematic diagram of a structure of the electronic equipment of the embodiment of this application, including the file processing apparatus of Embodiment 2. It should be noted that such a figure is exemplary only, and other types of structures may be used to supplement or replace this structure for the realization of telecommunications functions or other functions.

As shown in FIG. 8, the electronic equipment 800 may include a central processing unit 801, a communication module 802, an input unit 803, an audio processing unit 804, a memory 805, a camera 806, and a power supply 807.

The central processing unit 801 (which is sometimes referred to as a controller or control, and may include a microprocessor or other processor devices and/or logic devices) receives input and controls each part and operation of the electronic equipment 800. The input unit 803 provides input to the central processing unit 801. The input unit 803 may be for example a display screen, such as a touch display screen.

In this embodiment, the central processing unit 801 is configured to record post information in association with a local file, when the local file is posted in a social network to form a posted file; and record a comment content in the social network related to the posted file in association with the local file according to the post information.

Furthermore, the central processing unit 801 is configured such or that the post information and the comment content are recorded in the local file, or are recorded out of the local file.

Furthermore, the central processing unit 801 is configured such or so that the post information and the comment content are recorded in attribute information of the local file.

Furthermore, the central processing unit 801 is configured such or so that the post information and the comment content are recorded as metadata in the attribute information of the local file.

Furthermore, the central processing unit 801 is configured to detect the comment content in the social network related to the posted file, search the local file corresponding to the comment content according to the post information, and record the comment content in association with the local file.

In this embodiment, the communication module 802 is a transmitter/receiver transmitting and receiving signals via an antenna 8021. The communication module (transmitter/receiver) 802 is coupled to the central processing unit 801 to provide input signals and receive output signals, this being similar to the case in a conventional mobile communication terminal.

A plurality of communication modules 802 may be provided in the same electronic equipment for various communication technologies, such a cellular network module, a Bluetooth module, and/or wireless local network module, etc. The communication module (transmitter/receiver) 802 is also coupled to a loudspeaker 8041 via the audio processing unit 804, for providing audio output via the loudspeaker 8041. The audio processing unit 804 may further include any suitable buffer, decoder, and amplifier, etc.

In this embodiment, the camera 806 is used to take image data and provide the taken image data to the central processing unit 801 for use in a conventional manner, for example, for storage, and transmission, etc. And the power supply 807 is used to supply power to the electronic equipment 800.

The memory 805 is coupled to the central processing unit 801, and may be a solid memory, such as a read-only memory (ROM), a random access memory (RAM), and a SIM card, etc., and may also be such a memory that stores information when the power is interrupted, may be optionally erased and provided with more data. Examples of such a memory are sometimes referred to as an EPROM, etc. The memory 805 may also be certain other types of devices. The memory 805 includes a buffer memory 8051 (sometimes referred to as a buffer). The memory 805 may include an application/function storing portion 8052 used to store application programs and function programs, or to execute the flow of the operation of the electronic equipment 800 via the central processing unit 801.

The memory 805 may further include a data storing portion 8053 used to store data, such as the local file in Embodiment 1 of this application. A driver storing portion 8054 of the memory 805 may include various types of drivers of the electronic equipment for the communication function and/or for executing other functions (such as application of message transmission, and application of directory, etc.) of the electronic device.

An embodiment of the present disclosure further provides a computer-readable program, when the program is executed in electronic equipment, the program enables the computer to carry out the file processing method as described in Embodiment 1 in the electronic equipment.

An embodiment of the present disclosure further provides a storage medium in which a computer-readable program is stored, the computer-readable program enables the computer to carry out the file processing method as described in Embodiment 1 in electronic equipment.

The preferred embodiments of the present disclosure are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present disclosure may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present disclosure include other implementations, the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present disclosure by using the devices.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A file processing apparatus, comprising:
a first recording unit configured to record post information in association with a local file, when the local file is posted in a social network to form a posted file; and
a second recording unit configured to record a comment content in the social network related to the posted file in association with the local file according to the post information.

2. The file processing apparatus according to claim 1, wherein,
the post information and the comment content are recorded in the local file, or are recorded out of the local file.

3. The file processing apparatus according to claim 2, wherein,
the post information and the comment content are recorded in attribute information of the local file.

4. The file processing apparatus according to claim 3, wherein,
the post information and the comment content are recorded as metadata in the attribute information of the local file.

5. The file processing apparatus according to claim 1, wherein the second recording unit comprises:
a detecting unit configured to detect the comment content in the social network related to the posted file;
a searching unit configured to search the local file corresponding to the comment content according to the post information; and
a third recording unit configured to record the comment content in association with the local file.

6. Electronic equipment, comprising the file processing apparatus as claimed in claim 1.

7. A file processing method, comprising:
recording post information in association with a local file, when the local file is posted in a social network to form a posted file; and
recording a comment content in the social network related to the posted file in association with the local file according to the post information.

8. The file processing method according to claim 7, wherein,
the post information and the comment content are recorded in the local file, or are recorded out of the local file.

9. The file processing method according to claim 8, wherein,
the post information and the comment content are recorded in attribute information of the local file.

10. The file processing method according to claim 9, wherein,
the post information and the comment content are recorded as metadata in the attribute information of the local file.

11. The file processing method according to claim 7, wherein the recording a comment content in association with the local file comprises:
detecting the comment content in the social network related to the posted file;
searching the local file corresponding to the comment content according to the post information; and
recording the comment content in association with the local file.

12. Electronic equipment, comprising the file processing apparatus as claimed in claim 2.

13. Electronic equipment, comprising the file processing apparatus as claimed in claim 3.

14. Electronic equipment, comprising the file processing apparatus as claimed in claim 4.

15. Electronic equipment, comprising the file processing apparatus as claimed in claim 5.
